(19) United States
(12) Patent Application Publication
(10) Pub. No.: US 2022/0084148 A1
(43) Pub. Date: Mar. 17, 2022

(54) INNOVATIVE E-DOC TRANSFORMATION, CONVERSION, PREPARATION, AUTO FILL , MULTI FORMAT EXPORT, SHARE AND COMPLETION INTEGRATED WITH USER SYSTEM, E-DOC PERMISSIONS AND OPTIONS PER USER KINDS

(71) Applicant: genie ems, VERDUGO CITY, CA (US)

(72) Inventor: Genie rafaela Ems, Glendale, CA (US)

(21) Appl. No.: 17/022,082

(22) Filed: Sep. 16, 2020

(51) Int. Cl. G06Q 50/18; G06F 40/174; G06F 40/103; G06F 40/151; G06F 16/93; G06F 21/62

(52) U.S. Cl. CPC G06Q 50/18; G06F 40/174; G06F 21/6209; G06F 40/151; G06F 16/93; G06F 40/103

(57) ABSTRACT

Disclosed herein is an innovative invention to modernize document complete with use of technology and in integration with a user based system accessible by website online or by desktop app. E-Docs will change by auto-fill user data and user modification, also export. In order to efficiently complete document(s) related to real estate, property, professional contracts and other related docs further defined, the present invention will transform, convert, auto fill and provides other options including, but not limited too, user modify, execute, import, save, multi export. A user will have pre-templet documents to select depending on user-kind or a user can upload their own documents of which will be auto converted. Each e-document is coded in a way the provide designated portions of the document per user kind, this will enable single and or multi user completion on one document at the same time.

### FIELD OF THE INVENTION

The present invention provides method and system usage related to document transformation, conversion, auto filing, electronically prepare and completion document(s) in integration with a user based system with multi user options also connecting individuals such as clients apart of a process. Primarily usage is for individuals that need to complete real estate document(s), property documents, contract(s), other such generally related documents, legal instruments.

### DESCRIPTION OF THE RELATED ART

At present, documents including forms, contracts and other such generally related documents and forms that are related to real estate are primarily filled out in a physically location, this usually due to the fact that the process may involve multiple parties, possibly many documents and specifically in real estate, a real estate agent is a licensed professional that often buyers and or sellers feel most comfortable to go to in order to complete all necessary paperwork while having guidance throughout the process. Real estate paperwork can entail many documents to be completed, requiring information, multiple initials, signatures, dates, final error checks including completion of and distribution to all parties, this causes each real estate transaction to take a great portion of time to be complete.

Often, homeowners may not be as willing to put their home on the market because of the general outlook of the entire process including the amount of paperwork that comes with the process. However, the goal with the present invention is to provide a useful method integrated with a user system to provide great results and a solution in a way to accurately and efficiently completed documents for real estate agents, brokers, buyers, sellers, and other parties and individual needing to complete a document and or documents that relate to real estate, property, contracts, and other such related documents.

Currently there are companies on the internet in the field of real estate, however, most of them only display the MLS, maps and provide a user ability to claim there account or home and offer them an appointment with a real estate agent which usually ends up being by phone or in office. Some other advances including marketing analytics on a sellers listing, ability for users to upload a PDF document on a dashboard where it is viewable. but this still has not solved the process of the actual paperwork being completed electronically and in an automatic method to save time. The more time we save, the more time we have.

Property and business contracts are legal instruments which are often related to money, property, will require the highest amount of security, knowledge, and acknowledgment of all parties executing these such documents, therefore, technology needs to be used in its maximum capacity in this field.

Accordingly, the best way to promote safety, accuracy and speed of a real estate transaction or any other transaction or contract that involves documentation and property being sold or leased or other business contracts, is with usage of smart and unique technology, as this invention provides.

The primary questions an individual may have in an auto fill and full e-document completion method for a transaction or legal instrument is how can it be done, what guarantees safety, what source information can it draw from to determine accuracy, how can all parties be involved in a transaction separately or at one time, which parts do the parties fill out and method of document distribution, all of these questions, this invention has clearly solved providing a great tool for all parties involved.

The present invention provides an innovative way for documents to be completed with use of technology, users having access to their documents including can prevent errors, can prevent fraud, can increase speed of buying and selling process, can ease the documentation portion outlook of a transaction or other contract execution process, thus, lead to more trust as the user has full control of their document and their dedicated portions of the document.

To emphasize dedicated portions of their documents, this invention presents a way to convert then tailor permissions and options within a document to dedicated parts to a user-kind Giving users permissions only for their required parts, is a great method provide a clear direct guide to each party to see what portions of a document is exactly for them, it prevent parties from filling out sections they are not authorized to fill out, and enables multi user interaction on one doc at the same time.

Aside from the other many features a user will have of which will be further explained in this non provisional application, with the final execution and completion of the document, the user will have options to export the document(s) in a selection of different formats or share it with a link or send it by email and or print.

### SUMMARY OF THE INVENTION

Disclosed herein is a summary of the present invention. The following context in this summary classified portion is simplified to be put in summary from, therefore, it is not intended to limit the scope of the present invention.

The present invention provides a innovative method to convert, transform, auto fill and complete documents accurately custom with user permissions within the document and others options such user options including to modify, edit, import, and also upon competition by providing multiple export file type options, therefore, also transforming a document from its original state.

This invention is in integration and involves a user based system of which will be accessible by the user primarily online (web based) and also by desktop (with compatible system app).

To start off, in order to be compatible with the user system, a document needs to be transformed and converted and once a document is in an electronic file, it will be converted to a programmed language file and programmed with coding in order be integrated with the user system. The converted document will have user-kind permissions coded within it, so users will have different abilities, options, including permissions on the document and in the user system depending on their user-kind.

In relation to the user system, the users will have pre-templet documents already on their dashboard, also options for import. With the usage of designated portions in configuration with the user system along with database use, the document will have ability to be completed by a single user on their portion or even multiple users working on one document at the same time and also have unique viewing options. Once a user has completed the document, the user will have multiple output options on file extension for export also option to share their document.

As previously explained, in the process of completing legal instruments related to property, other business contracts and specifically in the real estate field, real estate brokers, agents, buyers, and sellers all spend a lot of time on the documentation portion as it is a very important part, however, it is time consuming filling out documents by hand and going over each portion of the document also double checking for any errors and making sure that everyone knows where to fill out their parts. The present invention will speed up the filling out of documents based upon accurate information obtained from user database including user input and other sources stored in the users database.

In real estate, if agents complete documentation portion much faster, they will complete a transaction much more efficiently and be able to focus on multi tasking multiple sales at once and even possibly expanding their time to get more leads. The present invention will ultimately modernize the buying and selling property process, and also the document filling out process immensely. As stated, it will work with a user type membership system that allows for sign up, sign in, storing user information, modifications, saving information to database, connecting people together also having a member dashboard as well as other integrations to the system.

The present invention will be primarily used for real estate documents, property documents and agreements, including, purchase agreement, deeds, broker contracts, realtor, seller, listing, lease, agency and other related legal instruments (including contracts and or agreements) also related to business, company, agency, and property.

Documents will also have option to be combined and when completed, to be exported in different formats or become sharable by email or link and printed.

In connection with the user system, pre-templet converted documents will be saved to database, made available to specific applicable user kinds (example: broker, seller, buyer, other licensed professional), also pre-templet documents will be specified by the location of the user. Aside from pre-templet documents saved in system, users will have options to upload their own documents to the dashboard (with compatibly instructions) to use with the user integrated system.

The following invention promotes primarily the Real estate and Property market to fully converting to become digitally modernized. Making buy and selling faster than ever. Promoting an efficient way to complete documents. Making it easier than ever to automatically put a property for sale or purchase a new property and or home securely and easily in a modern and digital way for finishing all documentation instantly and also providing multiple options for the user including view documents on a user dashboard also export and share. The present invention is very useful tool and contains great improvements to make it be easy to input necessary information needed on all real estate forms and documents based upon user information previously entered that will be stored on database and also information retrieved from other verifying sources. It also provide the user multiple methods of export and share upon document completion. As stated, may be used for various types of property, business related contracts.

### BRIEF DESCRIPTION OF THE DRAWINGS

The following drawings are presented to provide a greater understanding of the nature of the present invention. The drawings including the descriptions of the drawings are not intended to limit the scope of the present invention. The following figures may state FIGURE on the drawings and it will be abbreviated as FIG. in the following section.

FIG. 1 depicts an outline an overview from start to finish of the present invention.

FIG. 2 is an embodiment of the present invention to provide information of brief steps to create a user account.

FIG. 3 depicts the steps of an existing user to auto filling a document up to the final completion.

FIG. 4 is an embodiment of the present invention to show an overview of the document transformation process, with a different view to emphasize to how user-kinds will be pre configured (coded and or programmed) with user permissions and options per user-kind, and integrated with the user system, to the document, and to a database.

FIG. 5 depicts user options, further permissions, and view permissions on a document. The following figure is presented to show ability of multi user activity to work on one (e-)document at the same time.

FIG. 6 shows the method in the present invention allowing for certain authorized user kind including a broker and or other licensed professional, to have ability to bulk import user data, send requests for users to join in order for those users to claim their account with data already imported.

FIG. 7 shows how users will have capability to combine their completed documents for downloads in bulk or single download and export in multiple file types, or share by email, link, and options to print.

FIG. 8 depicts a potential sequence of events in a transaction of multiple parties.

FIG. 9 depicts a user dashboard with pre-added (pre-templet) documents appropriate per user-kind, and an ability for a user to import their own documents to be converted to and with preferences of the user based system.

FIG. 10 depicts a schematic sequence to an auto search, find, and replace method in conversation process.

FIG. 11 provides a visual illustration of a document opened by a user including highlighted areas for a specific user kind who is working on the document, option to edit, submit, self help question mark, and a manual auto fill button.

FIG. 12 is a visual illustration to show that multiple users in the system can be connect on a user based membership system and receive instant communication including notification upon certain user action. Additionally explain how the auto filled documents will integrate with the user membership system.

A. FIG. 12 A is an image to represent user system connection. B. FIG. 12 B is an image to represent a notification upon selection. C. FIG. 12 C is an image to represent an agent accepting and e-signing an auto filled agency disclosure.

FIG. 13-A-F provides digital visual illustrations of a user based system in relation to real estate user based platform showing a simple profile, user sign up process, selection of an agent process, again, the following images are brief and provide for visual explanation, they are not mean to limit the scope of the present invention including capabilities of its user based system.

FIG. 14 A-K—is a simple illustration with placeholders to show the conversation and transformation document process, followed by is a visual image created in php code to display simple user dashboard integrated with a user based system for a real estate platform.

### DETAILED DESCRIPTION OF THE INVENTION

The present invention is described in this section with references to the drawings, wherein reference with numbers and letters will be used to reference elements. This section describes in detail how the present invention works, however, this section is not meant to limit scope of invention also including programming language and or source code use to achieve the method and result of this invention.

The terminology used herein is for the purpose of describing this section for detailed description invention and is not intended to be limiting to the invention. As used herein, the term ‘and/or’ includes any and all combinations of one or more. As used herein, the singular forms of ‘a’ ‘an’ and ‘the’ may also be intended to include plural forms as well as singular forms, the context will be self explanatory on the meaning, unless the context specifically indicates otherwise. Unless indicated otherwise, the terms used herein have the same meaning as commonly understood by one having ordinary skill in the art to which this invention belongs. The terminology used in this description is purposed for describing the use, and is not intended to limit the scope.

Programming language used for this invention will be primarily PHP, but it is not limited to only PHP as other programming languages may be used in order to integrate code with the user database as well as for design.

Additionally, the term database is stated for the purpose to refer to a database as the method in which the data will be stored, however, it is not meant to limit the use in quantity or tables and or other structures of a database.

In terms of completion on a document an user may complete as many documents as appropriate in their situation, the document is deemed complete for a user upon their final submission (also known as execution) of the document.

### Overview (Detailed Description)

This present invention provides a unique and innovative way with the capital purpose to ease and complete filling out documents with use of smart technology from start to end for each individual partaking in the document, as accurately as possible, with single and multi user interactions and other options, thus, ultimately results to increasing the speed and accuracy of filling out documents and completing them efficiently.

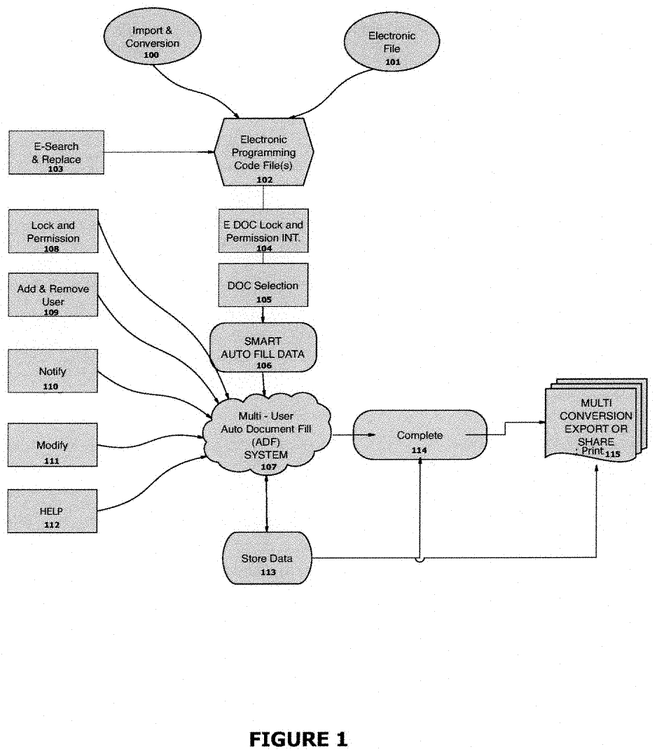

Referring now to FIG. 1, which shows an overview of the entire invention from starting process to completion. 100, 101, 103, are all guided with the same intent which is to make a document or form in a format ready to be converted to a programming language code 102 and with an applicable file in order to be compatible with a user based system, that will be used. Once a document is coded in such a manner to be integrated with the user based system, the document will have special features within its programming.

While the user based system will have many common and separate features per user-kind, in terms of document(s), depending on user kind it will including pre-templet documents ready for selection and also options for import documents by the user to their user document dashboard, that will required an auto 103 method to appropriately converted.

The designated areas for the user will allow the user to make modifications to the document mainly include the ability to text edit, input, delete, import, and a button to auto fill will also be provided on their portion of the document. In design preference, certain pop up boxes may also be provided in appropriate sections, if required per document kind. In import, the user will have ability and option to import their signature and or other media file into a designated and appropriate portion of a document. User will also have as stated many options on their designated section(s).

There will be features to assist a specific user kind if they have questions on how to fill out the document or what that portion means, a feature that will be included will be a question mark FIG. 11-B where the user has to click it on order to get a description, but this will be optional as it depends on user kind and the user system will provide a user multiple options to turn on and off such help preference on a document.

For real estate documents that are converted to be compatible with the user system and on the user dashboard, wherever appropriate, an equal housing logo will be placed on the document, also other legals depending on usage.

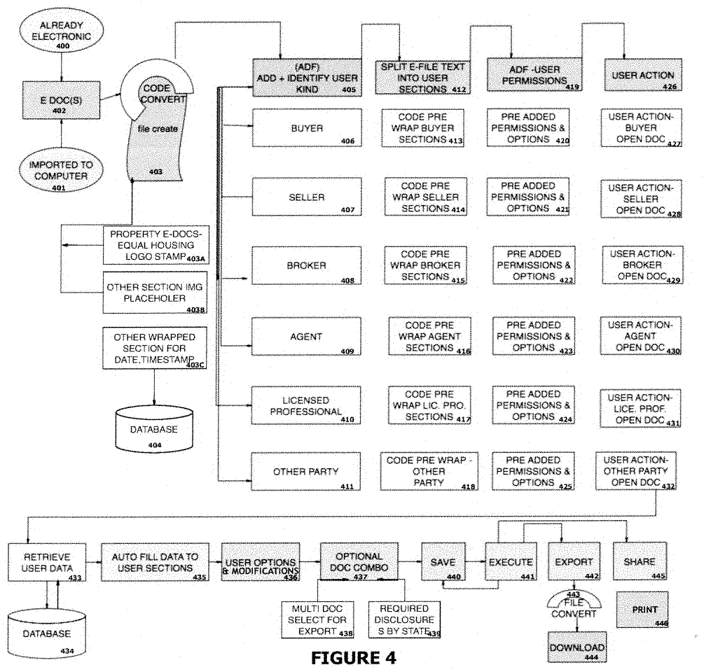

Referring now to FIG. 4, the primary focus is to first emphasize and separate the user kinds in order to provide the appropriate documents and forms per user kind and allow for auto fill, modification, import on designated portions 108 of the document or documents, form and or forms active per user kind.

Referring now to FIG. 1, No. 104, it is important that a document is coded in such a way to set up certain permissions so that a user can only modify, autofill, and do other actions only on their portions of the document or form based on their user kind. This provides extra security for all parties engaging in the document and makes it easy for an individual to know which parts are meant for them to fill out, referring now to FIG. 11, which shows an illustration with highlights to emphasizes to the user which portions of a document are meant for them. These user parts will be auto filled and user will be able to modify make other changes to their designated areas, each document may have different areas per user depending on the document.

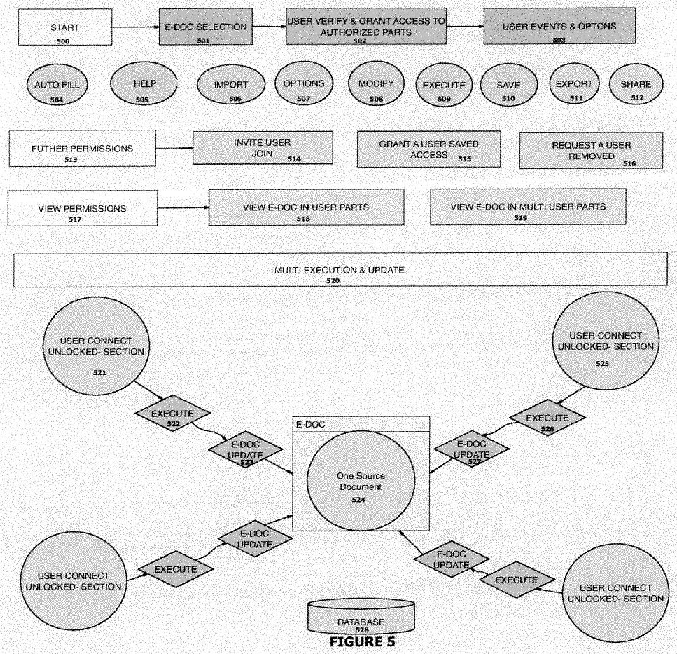

When there is one document that needs to be completed by multiple individuals, it may take some time for it to go around to all parties, this invention also solves that issue. Referring now to FIG. 5, No. 520 through 528, by setting up designating sections on a document by user kind, this will enable multiple users to be able to work on one document (on their selected parts) at the same time if they choose. It is stated here that a user is able to work on his parts because although the document will be auto filled at first, the user will still have options on the document such as to edit and modify the document with input, upload, and changes (if necessary that is) on their selected areas if needed before final submission.

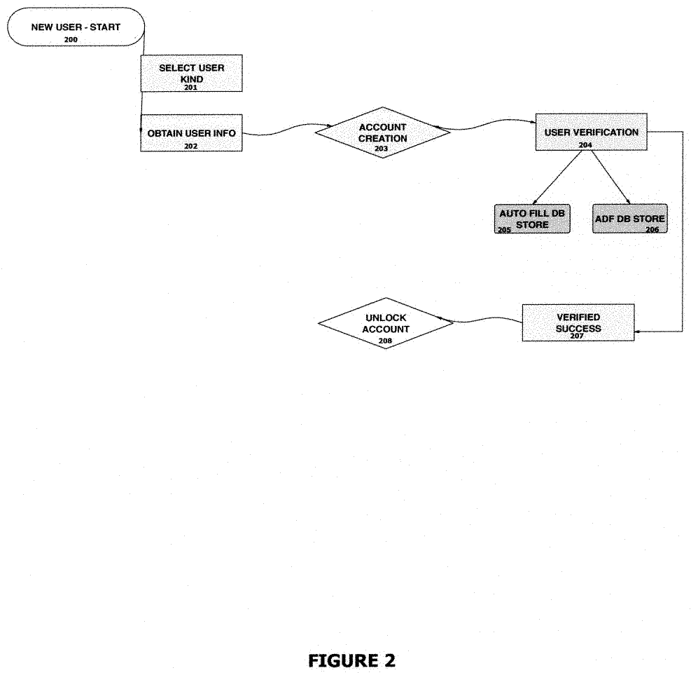

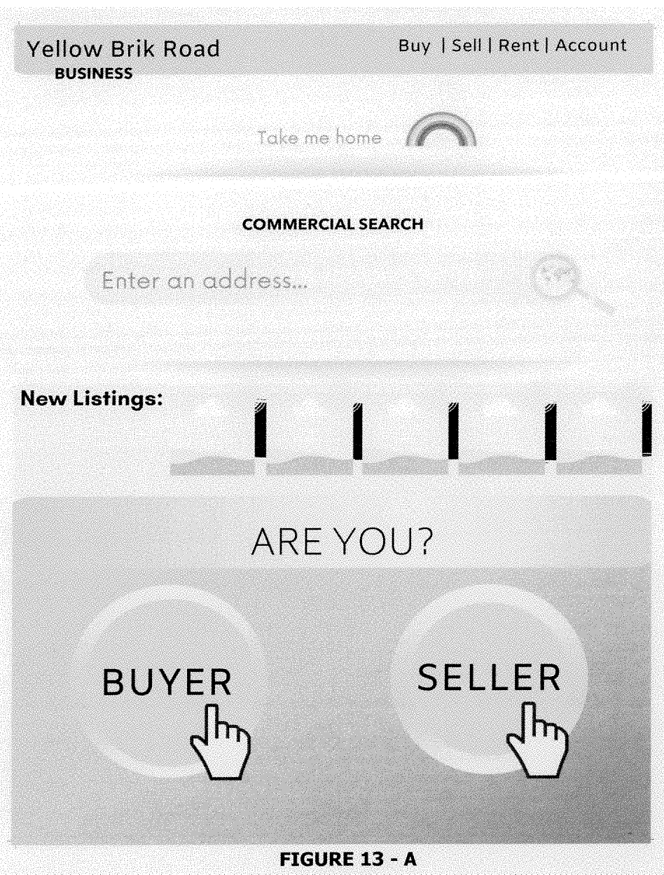

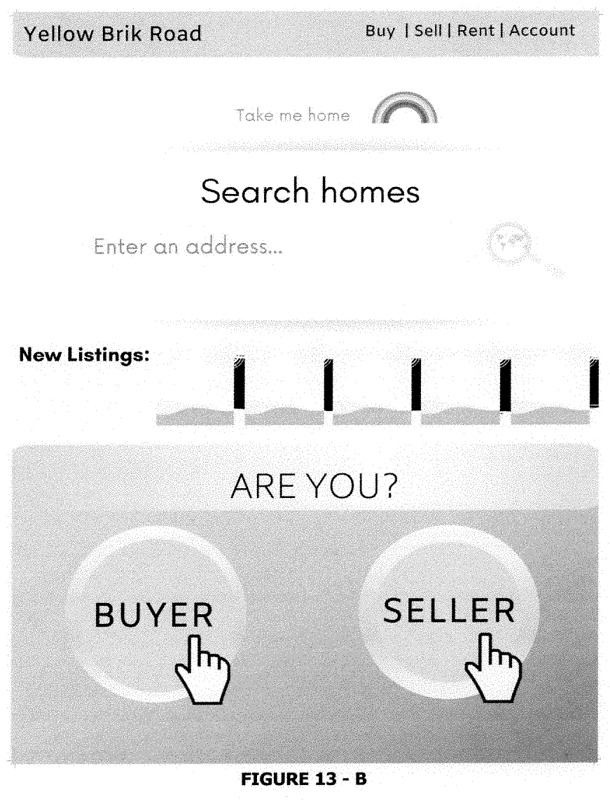

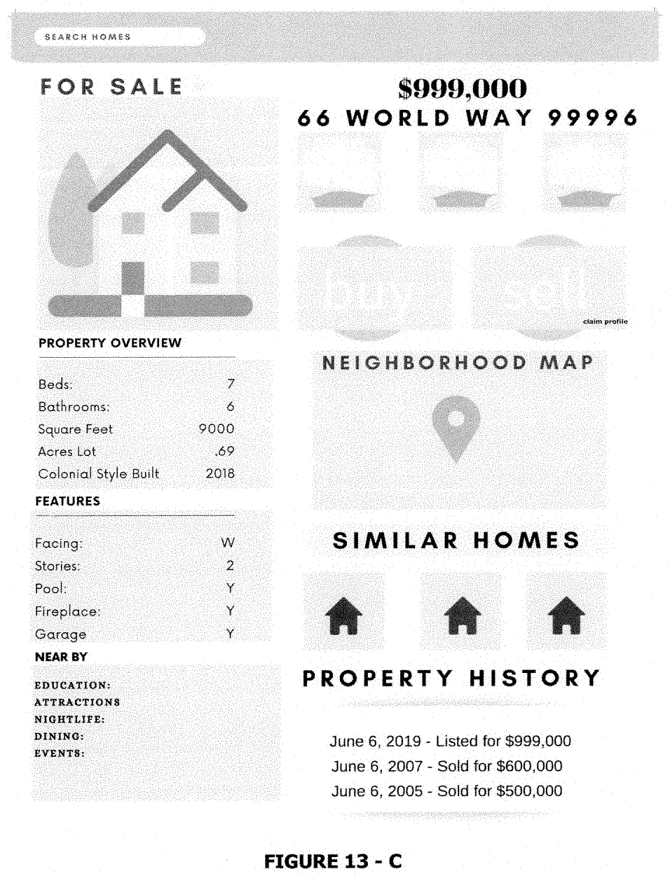

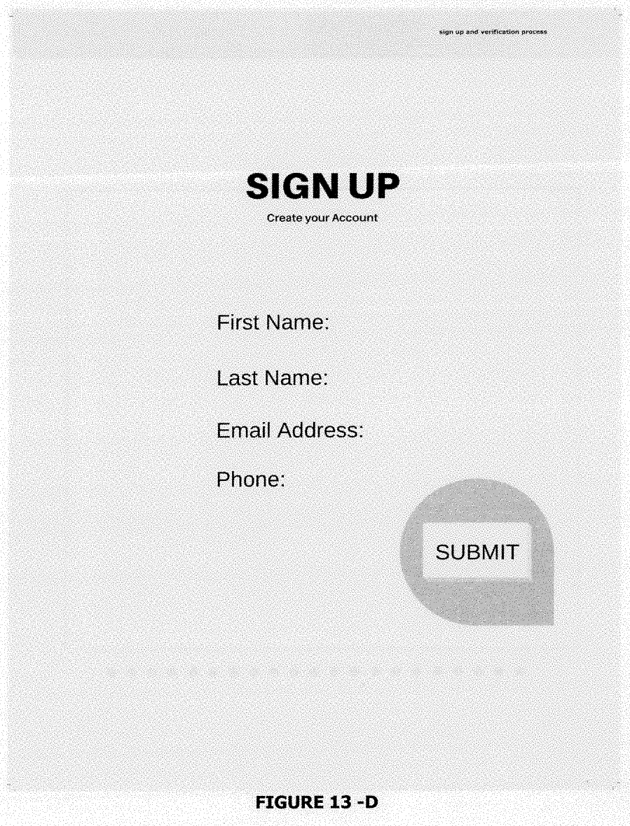

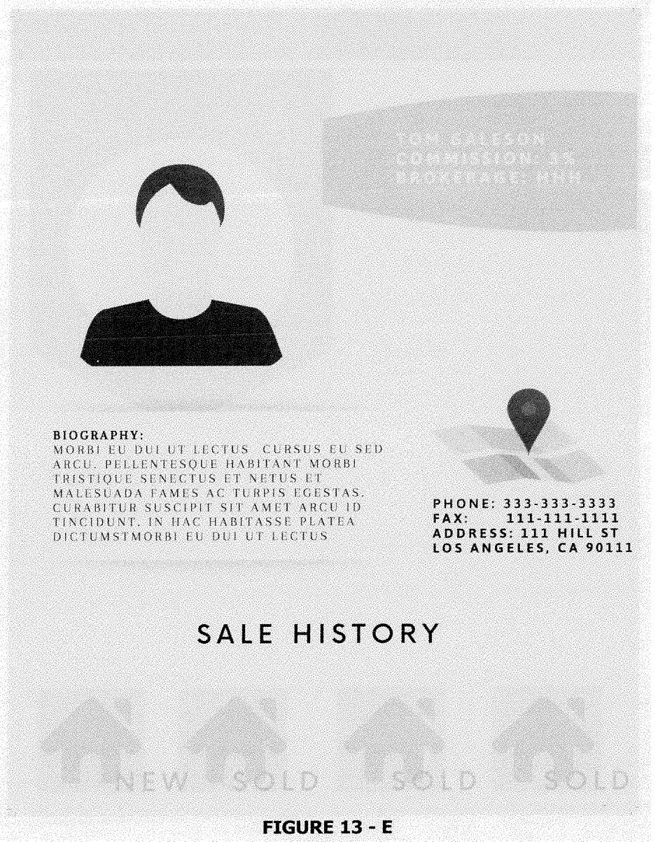

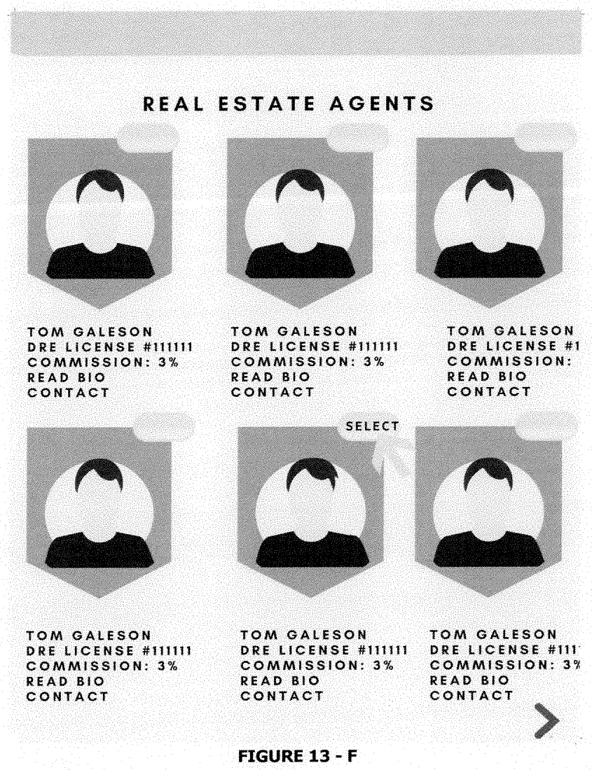

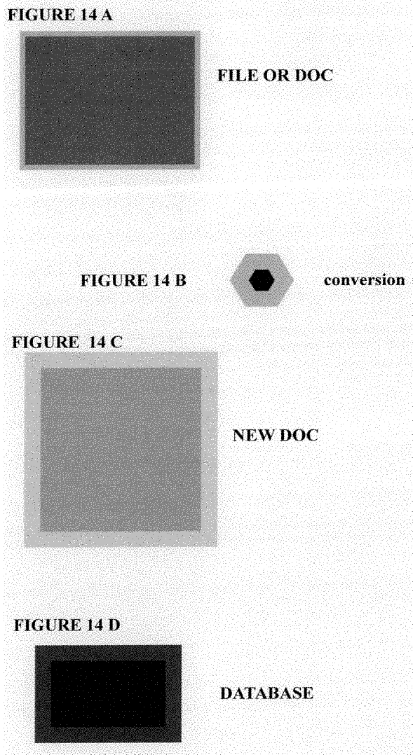

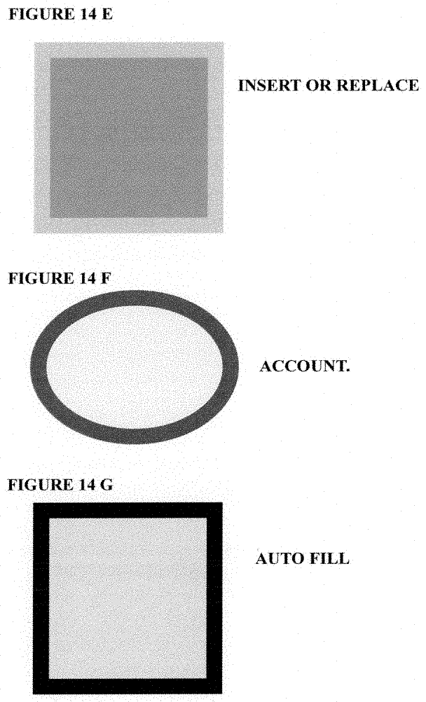

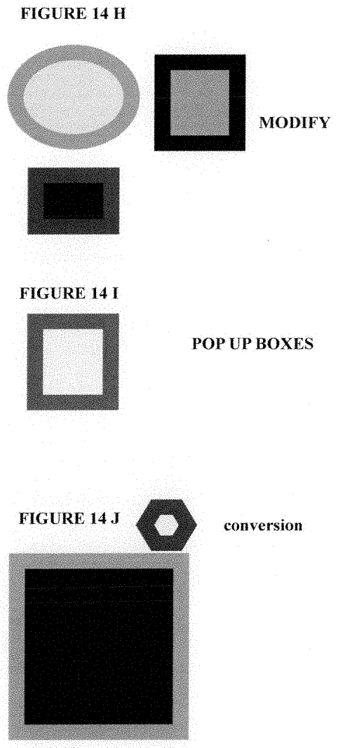

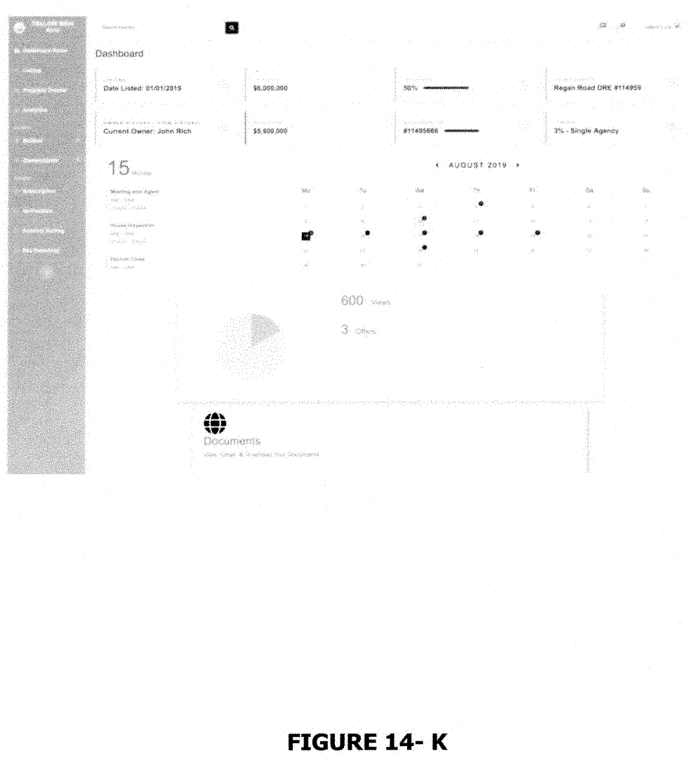

Referring now to FIG. 2, In order for an individual to be set up with the user system, they must provide information to create their account and that information will be verified to ensure security of the identity of the user. For a real estate platform with user membership platform system, a general visual sample of the process can be seen on FIG. 13 A-F, FIG. 13 A shows a sample commercial home page, FIG. 13. B shows a real estate residential home page, FIG. 13 C shows a home listing profile page, FIG. 13 D shows a simple sign up form, FIG. 13 E shows a profile view of an agent profile, FIG. 13 F shows a users option to select an agent, and FIG. 14 K is a user dashboard, however, it is to be noted, the provided figures are not meant to limit the scope of the present invention, that those figures are general and are not meant to specify all portions of the sign up system and so on. A user dashboard on coded in php shown on FIG. 14 K

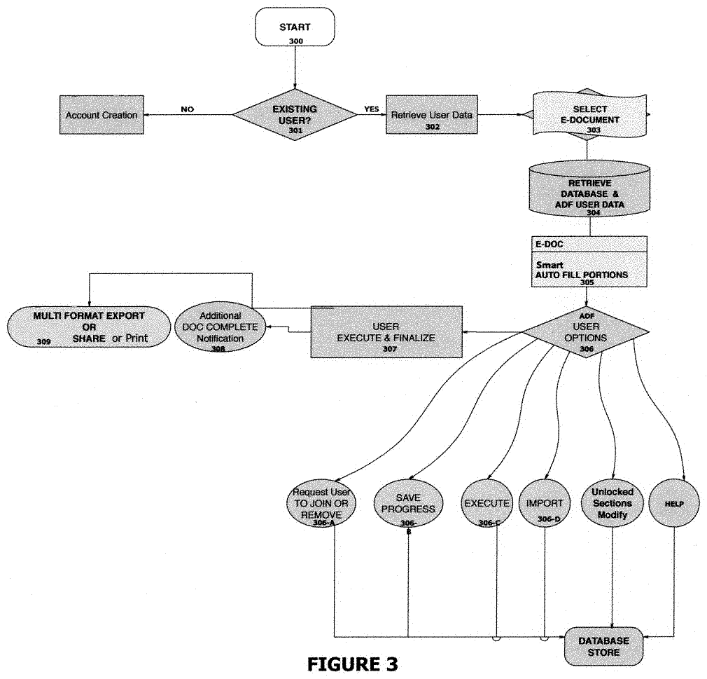

To ensure the highest level of accuracy in document auto filling process, the data which will be used to auto-fill the document per user will come from user input including information when a user is registering to the user based membership system (refer to FIG. 2 and FIG. 3 No. 304), also other user verification data, and also other retrieved data that will be stored inside the user's database on the Smart Auto Fill db section.

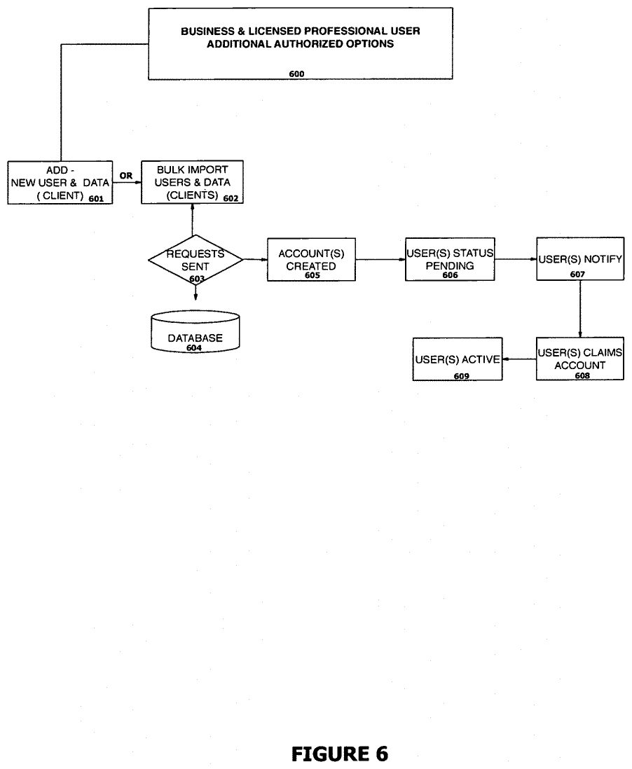

An example of other retrieved data for auto fill for this invention that stores in a user database, but not limited to other methods, as follows: Depending on user kind, there will be an ability to provide pre-stored data for another user. Referring now to FIG. 6. If a broker wants to invite one 601 or many of his clients to join the user based system 602, the broker will be provided pre-instructions (including required parts) on formatting and upload on how to import their data to the system. The brokers data may include the individuals info such as their name, address, email, other contact info and data, also if they are a ‘buyer’ a ‘seller’ a ‘contractor’ a ‘notary’, ‘other licensed professional’ and once the Broker imports data file to the user system, it will automatically create 605 and those accounts will be in a pending status for users 606. The individual and or user will be notified (depending on data provided, primarily by email) as the system will send out invitations including a link for the user to claim to claim account with data 607, once the user clicks the link to claim their account 608, the user will go through the verification process and once successful, they will have full access to their account 609.

Certain user kinds, will have different privileges, in a situation where an agent wants to auto fill another user's data (for example parts of his buyers data) without them having to create an account. Once agent provides certain authorization that the buyer (or individual) allows him, it will enable him to do so on designated portions without the buyer having to create an account.

In usage of a real estate transaction involving parties, a seller decides to create an account the membership user system. For sellers of property there will be additional user dashboard options including to claim their property. Starting the listing process, the seller might already have an agent which he is able to link up with on the user system or he might select a new agent to list his home for sale FIG. 13-F. Upon selection, he will then go to his dashboard where there will be a selection of documents available. The most recommended document will be shown first (although order of first document can be changed per user request), in this case it may be the Broker Agreement. Refer now to FIG. 3, Once the seller (existing user) selects the e-document 303, the document will automatically open, identify the user session, user kind portions on the document, and retrieve from appropriate database section to auto fill those portions for the user 304 & 305. The seller will have custom permissions based upon his user kind as a seller 306. Once the seller decides he (or she) is complete with his portion of the document, in the case that he may not be ready to execute because he may have questions or other concerns, the seller will have ability so grant saved access to share the file with another user (such as his agent) refer to FIG. 5 No. 515, once the seller will then execute and finalize 307, it will be saved to user system for that sellers data. If there is another party involved in the document, they will receive an optional notification upon completion of a party 308. It is stated optional because notifications may be turned on or off by users. Once the document has been finalized, then at any time, the seller wants to export or share it 309, her or she will be able to do so.

In a Multi user interaction in the process of completing a document, a buyer and a seller or other party may be working on document at the same time, there is no limit to how many individuals work on the document, it only depends on how many different applicable users (individuals/user-kinds) are required for input on the document. Refer to FIG. 5, No. 520,521,522,523,524,525,526,527,528. Each user will have their designated portions to work on as explained. If a buyer needs to add another party to the document, like a licensed professional, they may do so 514, if a party decides to request a user to be removed, in a situation where they no longer require that individual to be apart of the document, the user has ability to request that user to be removed from the document 516.

Each user will viewing ability to see their portions only on the document or to their portions and executed portions of the users on the document 517,518,519, as well as many other options, 503-512

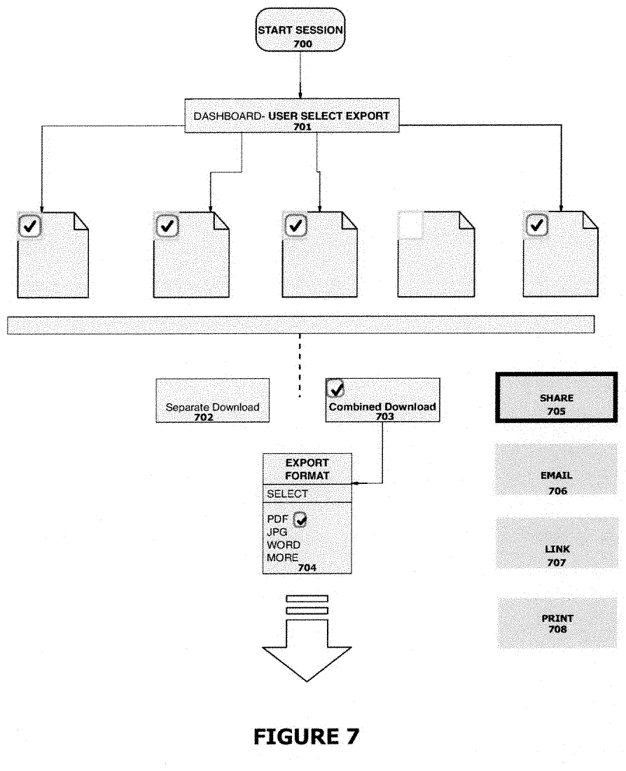

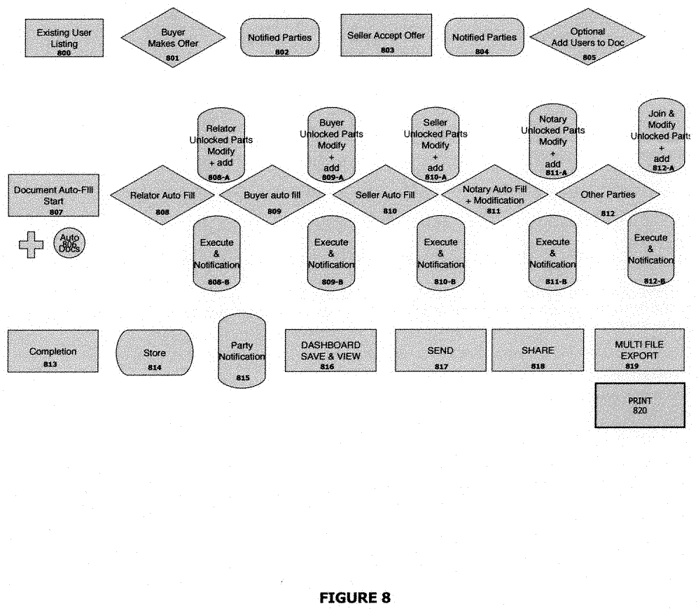

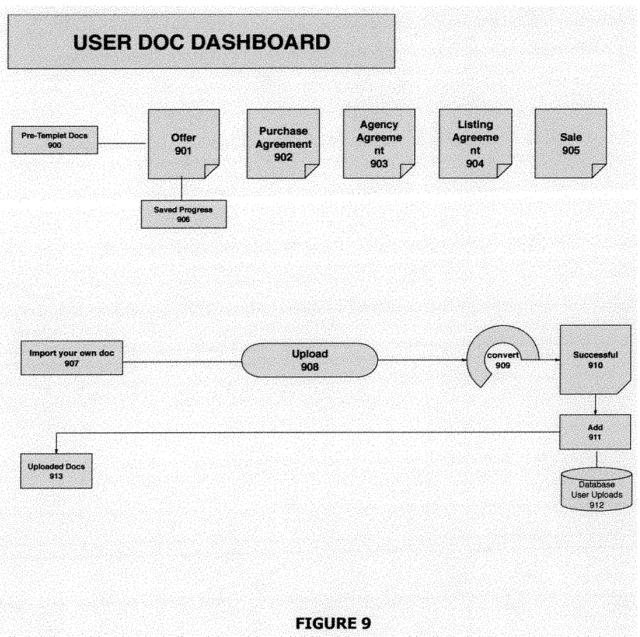

Refer to FIG. 7. When a user has completed his or her document(s), the user can then select his or her documents for export 701, the user will have option to do single 702 export or multi export of the document or documents 703, in multi file export options 704 or sharing 705 by email 706 or link 707. The user will also be able to print.

Users will have access to the user system online via a website or by desktop or on any current mobile compatible device.

Site may required certain permissions from the individual such as camera and mic access to be compatible with other features.

### Creation and Usage of User System (Detailed Description)

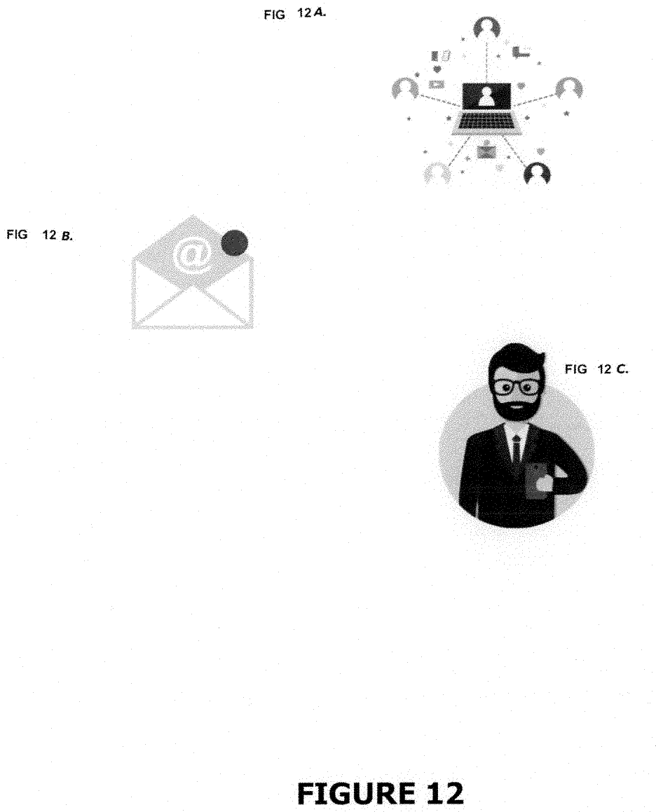

The present invention involves a custom created user system and integration to that user system. The user system will also provide notifications and communication for the parties involved in a document, a simple illustration show on FIG. 12.

Refer to FIG. 2, a general outlook of the sign up process. Each individual that wants to become a user has to create an account, select a user kind, verify their data, and be provided access. Although, there is also another method to creating a user account, see FIG. 6.

Appropriate Documents and forms related to the user kind and also accompanying the location of the user kind, will be pre-added on the user dashboard per user.

Each user will have custom permissions and options on their account, permission levels and certain other options will vary depending on the user kind.

Within the documents on their dashboard, if and when opened by the user, the user will have locked and unlocked portions on the document, meaning they will have designated sections on the document allowing certain action to be performed upon including type, auto filling, deleting, modifying, importing, as well as other actions further specified in other sections of this non provisional.

This user system will be accessible to users online as a web based application such as a website accessible by a phone or computer or by desktop.

The process of designating multiple user kinds, enables multi user modification on one document at the same time.

At times, if it will be necessary, the user will also have other permissions on the user system that they can enable to access such as to allow camera and voice use.

The user will have capability to auto fill, modify, save, export and share a document, as well as other options stated in this non provisional to make the document completion process much more easy and efficient.

User system will also have ability to integrate with multiple API's.

### First-Import, Conversion and Electronic Files (Detailed Description)

In order for users to have accurate auto fill documents and ability to securely edit & modify their designated areas on a document, the present invention takes an electronic file (whether imported to become electronic or already electronic), converts it to programming language file and codes in integration with a user system and tailors custom user permissions onto the document, this results to the user and or users have certain options and access on the document on their designated portions and upon final submission will user(s) have ability to export (in various formats), share, or print document or documents, thus transforming the document from its original state to a completed format.

The process does not always start with a document having to be transformed into programming language as pre templet documents will that have been already transformed will be on the user dashboard (depending on user-kind are ones on their dashboard), however, if a user wants to import his or her own form, then the process of transforming the document will occur 103.

Starting off, Referring now to FIG. 1 is an illustration to provide a general overview of the entire invention process from start to finished result. No. 100 & 101 in FIG. 1, represent the starting source, which is a document, it will either be already electronic No. 101, or it will be imported be converted to an electronic document No. 100. For efficient conversion, the document should be on a computer device and once the document becomes electronic, it will then be converted to an electronic programmed coded file FIG. 1. No. 102, which will then be coded in a manner in order to be compatible with a user system that will be used for this entire process.

To define what kind of document and file types will be imported, converted (FIG. 1. No. 100) and or already electronic (FIG. 1 No. 102) are as follows, file or files and or document or document INCLUDING FORMS, also with text pertaining to the following legal instruments such as real estate contracts, property contracts, purchase, sale or lease agreements, listing and agency agreements, association of realtor forms, other such contracts, and business related agreements and other such related documents as further detailed in other parts of this non provisional patent. Also all images of such documents or files. Electronic files (FIG. 1 No. 101) may be in .PDF, WORD, .TXT, .JPG, JPEG, as well as other formats normally accessible by computer usage deemed as such related electronic file(s), and as already explained, documents and or files containing text, will be converted to a programing language (FIG. 1 No. 102) file and coded with a programming language in compatibility with a user system.

Definitions of Document by dictionary.com

Document as a noun definition: 1. “a written or printed paper furnishing information or evidence, as a passport, deed, bill of sale, or bill of lading; a legal or official paper”
2. “any written item, as a book, article, or letter, especially of a factual or informative nature.”
3. “a computer data file.”
Document as verb definition by dictionary.com: 1. “to furnish with documents.”
2. “to furnish with references, citations, etc, in support of statements made.”

### Second—Conversion to Programming Language (Detailed Description)

Once the document becomes electronic, it will then be converted to a programming language to be customized, compliant and integrated specifically for a user based system. The primary programming language will be PHP, but not limited to other programing languages.

After the process making the document electronic and digital. Further, on the method to convert a file to programming language code compatible with a user system, we must first obtain the context (and or source) of the file or document, in which the source of it meaning in this situation, is first the text, its context. Aside from importing documents to a computer and making it an Electronic file, Obtaining the source may be done manually as well, such as creating an Electronic File document, legal instrument or contract, on a computer or having it already on a computer obtained through other sources such as online download.

The document will be coded to PHP and converted to a PHP FILE, but not limited to on PHP as other programming language codes and compatible files that may be required in connection user system.

Once the source of the document is extracted, which the source is its data within such as context, text, then it will be coded with programing language to be integrated with the user system and then custom programing code will be placed in areas of the document that require input from a party or a description of an item and other such related section, this code is tailored to draw and show results from the user based system database for the auto fill process.

For process of converting the electronic file to a programmed file in connection with a user integrated system, primarily done with custom PHP coding to be added to blank spaces of a document requiring individual input such as before or after or in between certain sentences, phrases, word, words, or letters, certain characters and or symbols of the document, but again not limited to other programming languages that may be integrated in connection user system.

Further, Programming language is inserted in these stated locations for purpose to retrieve database data which included text data and even media files and display them on the document for each different user-kind (party involved in the document), example, buyer, seller, agent, contractor, etc, but also configure the document with certain options and permissions per user kind.

Once the document is coded with appropriate programming language, After conversion, it will be stored to a database also to be configured with a user system. The specific PHP code will be added so that the document (or documents) and or file (or files) to display information on those sections requiring information from an individual or individuals to fill out and provide options and permissions on the document based on user kind. The programming code added will obtain information from database and save. Other programming language code may be added and saved.

Further defining ‘blank’ sections or ‘blank or empty space’. Those ‘blank’ sections, may not always necessarily be fully blank, they may have an underline or not, the main element of focus is that those sections exist on a document, created for a person or persons or company to input and or write certain information on those portions of the document. Specifically, those sections will inserted programming language code after a conversion of the document to a programming language file type.

Programming code will retrieve from information, Connecting to a database containing information both by pre entered information and user information, user inputted information and also other sources relating to the user.

In the process of conversion, the blank space or spaces of a document meant for user input will also be replaced with specific programming language code compatible with a user system FIG. 1 No. 107. In the process of conversion, any remaining ‘&NBSP’ text upon conversion, may be replace on the document with programing language code if applicable, and it is stated if applicable here because it is based on the type of file that will be converted if that phrase &NBSP will be showing on underlined or certain empty portions of the document.

### Dividing Document into Sections with User-Kind Permissions (Detailed Description)

A database integrated with the user based system will have different user kinds in database, different permissions and options for document modification, auto fill, import and other features will be available by user kind.

Documents that will be converted to E-Docs and integrated with programming file and code compatible with a user system, will display on a users dashboard depending on their ‘user kind’, refer to FIG. 4, No. 403, in document conversion to programming language there will be sections with placeholders for images to be uploaded 403b, other sections for date and or timestamp both manual and auto input 403c, and in property documents requiring equal hosting logo, it will automatically be placed on the document(s) 403A, once document is converted to a programming language compatible file with the user system it will be stored in the database.

Once the file is save, the document(s) will further to be integrated to comply with the process. We first need to identify what parts are in the document(s), what individuals will be apart of the document, the main categories will be a buyer 406, seller 407, broker 408, agent 409, licensed professional 410, other party 411, these individuals will also be dividing and added into the database. After we identify what parties are in a document, then we will move on to splitting the document text into sections 412 by appropriately adding programing code per user kind, 413-418.

Referring now to FIG. 4. In further specification the word ‘Wrap’ is stated in FIG. 4 No. 412-417 for purpose to identify the sections and to surround w/insert on selected sections of the document with coding in locations requiring input per user kind in order to specify what that user kind is and in integrate with the user system as well as database to retrieve data of that user-kind and integrate with permissions 419-425.

With the database splitting up the different user kinds and the e-document being coded to split up the user kinds on the document, it will result to a user to have designated locked and unlocked portions depending on the user kinds.

After document is converted and applied appropriate programming code, then it will be designed with CSS (and other methods of coding design) in order to visually enhance, format and separate areas to the document.

Programming code is added to allow for media file uploads on designated portions of the document 403b, with user permissions. Such as designated areas on a document may be requiring a signature, will not be mandatory to be signed to export document, however, users will have option to import a signature only to the portion requiring a signature, the other parts of the document will be locked for that kind of specific action. Real estate documents with requirements of a mandatory equal housing logo 403a, will automatically have programming code to retrieve an equal housing image from a database and stamp it on the document making it viewable and, in effort to reduce size, options of CSS or other design code to create the same logo and stamp it on the document will be another ability.

The initial user action 426 when a user opens a file 427-432, first the user's data will be retrieved and specific data shown, in the situation where a user is opening the file (e-doc) that they will start on for the first time, the database will retrieve user data and auto fill the designated user sections 435, the user will have other options and modifications of which will also save 440 to database, optional doc combination will be available 437-439. Once the user executes 441 and or submits the doc for execution, it will be saved 440, and the user can select to export the file 442, once selecting the output kind, for example if it is .PDF, the E-DOC in programming language will convert to a .PDF file and of course have included and display the executed portions of the document. The user will also have option to share 445 or print 446.

Referring now to FIG. 5, this will enable many users to work on one document at one time and be able to it have auto-filled, saved, and executed for section, as well as having other options based on user kind. Users will be provided further permissions including to invite a user to join 514, grant saved access to a user 515, or request a user removed 516.

Once a selected document is open it will initially auto fill, user also has options to auto fill by clicking a button while on the document FIG. 11-A, however, after a user make changes to an auto fill document, those changes last saved will appear on the document.

In the process of coding a file (e-document) to have different portions to be designated for a specific user, will be a great method to allow a user to auto fill, modify, edit, execute, save, only their designated portion of the document. Users will also have certain viewing permissions, if a user is filling out his portions and doesn't want to see other individuals portions at the time he or she is filling out his or her portions, they can select the view doc in user parts 518, or if they want to view the document with all multi user executed portions they may select that option 519.

### User System Pre-Templet & Converted Documents (Detailed Description)

The result of converted E-documents, will be that they will be already available onto a user dashboard and types of documents will display based on user kind.

A quick example how it works, if a user is signed up as a real estate agent user-kind, the user will have pre-templet documents on their dashboard to select from that include agency disclosure, buyers agent contract, sellers agent contracts, purchase agreements, deeds, or lease agreements and other such related documents in the field applicable for their user kind.

To make documents more accurate and get more into specifications, these pre-templet documents will not only appear on dashboard deepening on the user kind, but also per user kind Location, usually when the location is a big part of the document. For example, there may be a Broker in the state of California that he has verified his location, he or she will have available real estate documents available which would be applicable for his or her state, which would be California in this case.

Users will have options to upload within the document on a designated area 306-D or to upload their own documents to the dashboard for conversion FIG. 1 No. 101,103, FIG. 8, FIG. 4, as this conversion process will occur to extract source, design, and program file compatible with the user system and user kind.

### Document Types for Conversion (Detailed Description)

This is an invention to auto-fill and complete documents including docs that have been forms, these documents and forms primarily are property contracts, agreements, deeds, broker contracts, agency contacts, agency disclosures, listing agreements, purchase or selling of property agreements, offers, power of attorney, other real estate agreements or property agreements or contracts, including, but not limited too, for residential, commercial, or business related agreements, contracts, forms, association of realtor forms, and other generally related documents also including a licensed professional and legal instruments that have empty portions which an individual including company needs to input his or her information as well as other information that will be required to be inputted by a party or parties to complete the document.

These document types also include, All Association of Realtor forms and documents and other such related document(s) will be converted to a programming language code and saved with an applicable programing language file and there will be specific programming language added to text before or after or in between certain phrases, word, words, characters, or letters, and symbols of the document or file. More specifically, the programming language will be inserted before or after or in-between a place or places that are meant to be places on the document which a party or parties, person or persons, would input or write certain information. Everything will be stored to database, database table in integration with the user system.

Additionally, all forms and documents will be divided in database tables per user kind and by different states of user kind, this will allow more specification including for users to have appropriate documents on their dashboard available by location and also certain mandatory disclosures required per state to also appear on their dashboard.

### Additionally Detailed Conversion—Search and Replace Methods Auto & Manual (Detailed Description)

Refer to FIG. 1 No. 102 and No. 103 when converting the document to a programming language file with code compatible with a user system including a database, the a search, find and replace method is essential.

Conversion means its definition, in this situation, for example to change a pdf file to a php file and change the pdf text into php programing language .PHP. Other formats may be used for conversion, not limited to only PHP.

The custom programming code added in the search, find, and replace method, will be programming code tailored to draw from database data that is integrated with the user based membership system.

The method of adding this coding can be manual or automatic.

A Document in a format as in a PDF file or doc or Text file, or image file, will be converted to a programming language code and a compatible file. It will be primarily converted to a PHP file, but may also be converted to other file types if needed (in order to always be compatible with the user based system).

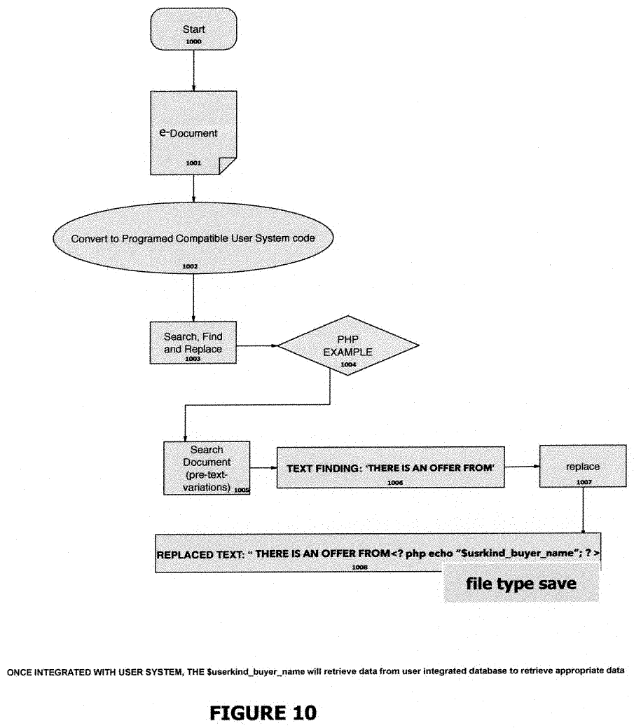

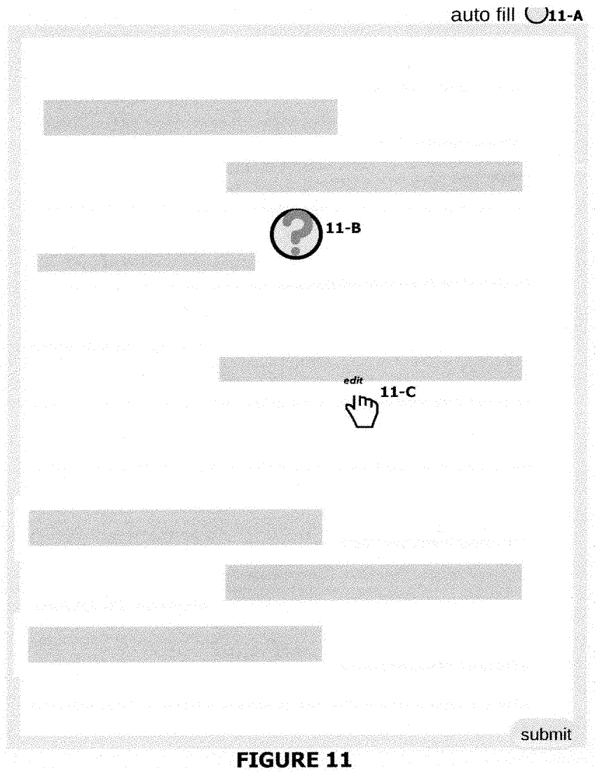

Referring now to FIG. 10, an auto method For an automatic search, find, and replace method, it will be done with a custom created application with a storage (including a database) in order to search for certain text and symbols on a document, find, and replace, auto adding custom programming code that will be compatible with the user system of this invention.

Users, will have option to select pre-templet documents in their dashboard. Pre-templet documents are documents that have been converted to programming code compatible with the user system and its unique features. Although there are many different documents, but they will vary which ones will be available to a user based on user kind including location of user kind.

Depending on the usage (pre-templet or user upload), whether it will be for pre-templet documents in the user system ready for user kind usage or if it is for IMPORT of documents by user that will be converted to programming language files compatible with the user system, the Search, find and replace can either be done manually or with other automatic method.

To explain the search, find and replace method, it is to search and find areas in a electronic document designated for certain input from an individual and then replacing with programming code to draw from a database in integration with a user system. * (document types for conversation are further specific in this non provisional patent)

In further clarification, once an action such a request 1000 to upload and or import an electronic file 1001 (for example in PDF) to the user system, the PDF DOC file type will be converted to a programing language code and file to be compatible with the user system 1003, an auto searching of text 1005 pre entered in the database and or other storage system will occur and for the a search, find and replace process 1003, programming language (primarily php 1004, but not limited too), once text is found 1006, is then inserted with programming language 1007 to commit events upon request, however, this is not limiting to be the only way, (depending on usage) it can also be done manually, such as to look up all phrases or specific wording or symbols on documents and insert, copy paste, and or type in programming language before or after or in-between certain phrases, word, letters or symbols on documents or file, specifically on places that are meant for a person or parties to write or input information. The main focus and point is that on certain text phrases, words, word, letter, characters, letter and symbol, or symbols that come before or after or in-between a space or place on the document or file that is an area meant for a party or parties, person or persons to input certain information, will be identified and there will be programming code inserted at that place. PHP is the main programming code inserted, but other languages may be inserted also.

Even if the keywords or phrases or letters are not added to database for an auto search, find, and replace method, there will be programming code added before or after or in-between portions of the document that require filling out by a person or persons, to achieve the purpose. It does not limit that the programming code may manually be added to those specific parts.

First step, is the Conversion of a file or document (singular and plural) that is in a PDF Format file type, Doc Format file type, Word file type, any Text document, Jpeg file, JPG file, other image file type, Png File, and or Image file to a programming language coding and also a programming language compatible file type.

After Conversion of a PDF document or a text doc to PHP coding it may often Show &NBSP on the blank spaces or empty spaces, and or lined empty spaces that are often mean to be places where a person would input his or her information.

After conversion of an electronic file to a coded programed file, if there are &NBSP text phrases remaining, then the Replacement can be done Either Manually or by Database auto pre-search phrase method so the blank or &NBSP and or on locations before or after certain phrases of a document or on the text of a file, will then have custom input of a programming code added. More specifically, but not limited to, it will mainly be PHP code added (or inserted).

For the auto method, the Database, database table, and or other storage system will have pre-search phrases and or selected words.

Methods above may also use other programming language, Conversion may also save to other programming language if needed and a file in other programming language if needed, in order to be compatible with the user based system.

The coding in the programming Language will be inserted after or before or in between certain key phrases, specific letters, letters and symbols, word, words, and symbols, manually or by copy and past methods and or by search and find method using the database information with pre-selected words and symbols. It will be code which will be used for the purpose of retrieving database information and displaying certain information on the file.

### Further Defining Text & Variations of Search, Find, and Replace Method (Detailed Description)

To define what will be searched for on the documents in the search, find and replace method, the Text and or symbol will be replaced and or there will be programming language inserted before or after certain phrases, letters, blank spaces that require user input (as further defined here), word, words, and or symbols. However, it is not limited to only letters. Letters may be with 2 or more letters or with 1 letter or more and a symbol and or a blank spaces.

The variation of phrases, words, letters, of text as well as symbols will be obtained by searching on all documents, all real estate forms and documents that have a term and or specific word or combination for words and symbols before or after a need for input of information to be written or typed.

Those key phrases will be, (but not limited to as more may be added depending on the exact wording of each document and forms), the first name of a person, last name of a person, brokerage name, address, home address, real estate agent name, license number and more information depending on what document it is and what information it is asking for.

Again, they will be specific key phrase words, word, letters, letters and symbols, phrases found on documents and specifically on all real estate documents, real estate disclosures, real estate agreements, buying and selling documents, property docs, other legal instruments and or contracts as well as other documents mentioned in this non provisional and depending on what is written on each document in certain locations requiring information, that specific text in a phrase, word, letter, letter and symbol will be obtained and there will be custom programming language inserted and or replaced before or after or in between the place requiring the information to be entered.

For example, a general California real estate document that is a California Purchase and Sale Agreement states in part:

______ (“Buyer”) with a mailing address of”
In this case we can and will store and add in database (“B, (“Buyer”) and we will add before that text custom programming language code to retrieve data from a user that is a Buyer on the user system.
However, another form, this one from the California Association of Relators, titled California Residential Purchase Agreement And Joint Escrow Instructions, states in part

### “1. OFFER

### THERE IS AN OFFER FROM ______” A.

In this case we can and will store and add in database AN OFFER FROM, OFFER FROM, and we will add custom programming language code AFTER that text.

Also document If during the conversion process, the underline or blank space converts to a ‘&NBSP’ phrase, then OFFER FROM&NBSP will be added to the database, for the auto method to insert programming language and or be manually replaced with custom programming language code such as PHP, but also other programming language code can be added.

After conversion to PHP or HTML and even Javascript and or other Programming Language, even if &NBSP shows in text or doesn't, options (again, depending on method of use) for conversion, read further below.

Search, Find, Replace Database method—creating a dedicated database or just a created database table containing certain variations of letters, words and phrases and or symbols to be used for auto search, find, and replace methods so selected php code can be replaced on per &NBSP or location requiring user input.

Again, this is optional way of inserting programming code in certain sections, it is not meant to limit or make it an only method because it can also be done manually such as by copy & paste or typing or replacing with programming code before or after or in between certain locations. A database is a method, however, other programming methods to hold data and perform actions upon data found, including with arrays, variables, and other coding method.

In an overview with placeholders to get, FIG. 14 A shows a placeholder image to represent a document, this document can be a PDF FILE, Word Doc, image file or image file in all different format file types, pdf document and or documents file or files, word doc or docs or file or files, other docs containing text, text document and or documents also file and or files. FIG. 14 B shows a placeholder image titled ‘conversion’ it is meant to describe that the document in FIG. 14 A will be converted to another form as seen on FIG. 14 C. Again, these figures contain placeholder images. FIG. 14 C shows a placeholder image to represent the document or file that was once in FIG. 14 A, but in FIG. 14 C the document will be converted to a programming language and saved in that compatible programming language file. It will be primarily be converted in PHP language and be saved in a PHP file, but may be able to convert to HTML or another programming language code and file if needed. FIG. 14 D_shows a placeholder image to represent a database, database table that will have in it information containing specific phrases, wordings, words, characters, letters, and symbols all well as tables with other information as this will be integrated with a user membership type of system. Aside from search and find process, even if not added to database those key phrases for a search, find, and replace method, there will be programming code added before or after or in-between specifically certain phrases, words, letters, symbols, and or certain portions of the document that require filling out by a person or persons. FIG. 14 E shows a placeholder image to represent a file and or document, the file or doc in FIG. 14 C which is a newly converted document in programming language and a new file type. Further, before or after or in-between certain words, letters, phrases, and or symbols, there will be specific programming language code inserted, PHP programming language will be inserted, also replaced if applicable if there are certain &NBSP phrases or blank spaces, however, other programming language may also be inserted if needed. It can be inserted in any way by either typing out the programming code or doing copy paste methods. The input can either be done manually or with a database search and find method, phrases, keywords, letters, and wordings and symbols will be pre added in database for this search, replace and insert method. This custom programming language that will be added is used for the retrieval of information and display part. FIG. 14 F shows a placeholder image to represent an user account connection. There will be a membership user system integrated with a database. A user account will be created, it may be created by a user signing up. Certain information stored inside database for user based upon user input and other sources of verification. This information that will be stored will be needed to for the retrieval part that will help to auto fill files specific per user. FIG. 14 G shows a placeholder image to represent a file, document, and or form which will be auto filled. Depending on which form or document or file is selected, and which file, form, doc is applicable to appear on dashboard of a user account or account, that file, by the custom programming code inputted prior as further explained in FIG. 14 E the file will retrieve specific user information from database and also other info from database, thus, changing the file and or doc that would normally have empty spaces that require a person or a party or parties to input his or her information with the information accurately already inserted appearing on the file and being already auto filled for the user.

FIG. 14. H shows a placeholder images to represent a file, doc, or form modification by user and saving of modification to database. User may modify the file on certain places allowed for editing and modifications. The modifications will be stored for users account in database and changes will reflect on the file FIG. 14-I shows a placeholder image to represent pop up boxes on a user account. Additionally, Locations that need check boxes on a form or document, will ask the user questions prior and depending what the user clicks or maybe types, it will store that information and modify the document or file and make the changes appear on the file. FIG. 14. J shows a placeholder image to represent the conversion from the file in a programming language to a document in PDF, WORD, or other document text type, also image file type possible, and also be able to be printable. This conversion of the file in a programing language to a document, as further specific in prior sentence, will have the accurate information auto filled and appearing on the document after conversion. Further, once file is fully completed, it will then also be able to convert from a PHP programming language file or any other programming language file if applicable back to a PDF file also other formats, also shareable and will also be printable._FIG. 14 K, provides an image of a coded user dashboard for real estate.

### Programmed Code Added in Connection to Retrieve from a Database to Fill DOC (Detailed Description)

Programmed code for a user system will have many features, however, in relation with completing a document user permissions and user data are necessary, and to do this it must be tailored with programming code compatible with the user system.

PHP is primarily used in this method and favor for its capability to draw & echo data from database as well as its other capabilities.

The php coding inserted will be connected in relation with a user type membership system.

As explained, usage in this search, find, and replace is a way of converting documents, such as first text files and documents, word docs pdf files, and image files to computer programming language. Then inserting code which will connecting to database, also a user system, inputting custom programming language code for information retrieval, and changing document or documents with accurate information.

Specifically, conversion of a file in PDF Format, File Containing Text, and Image file will be to a PHP programing language and save as PHP file. However, other programming language codes such as HTML and others may be used in order to make the document compatible with the user system.

By programming language, It also equally meanings programming language code. With a document being transferred into programming language, it will also save to that compatible file of the programming language.

Further custom code of programming language that is added to specific portions is mainly for the purpose of retrieving information such as database information and displaying information back on the specific portions of the document.

Aside from just retrieving, is also used for key features per user kind and allowing modification of information on the document and storing that new information inputted

The data on the user system database will be retrieved to display on certain portions of a document to auto fill documents for a user, is not only limited to data obtained by user input.

Upon user input of information on the member system and other sources of verification stored in database, the document that once had empty spaces meant for a person input information, will be auto-filled with information based upon database information. The text of the auto filled documents will be viewable to the user on the document.

In an overview of the auto fill process, once a user accesses the user system, the user will first have to select a document to open it on their dashboard and once open it will be automatically filled out on their designated sections with accurate user data drawn from the database. The user will have option to also click a command button to auto fill and clear fields of auto fill. The user will have option to modify their designated portions on the document even after auto filled and once the document is open again, it will have the users stored data saved in their session.

This database information will be accurate per user data.

### Auto Fill Data (Detailed Description)

The information which will be auto filled (106, 504, 305, 435,807) on the document and forms of the user will be information collected upon the user input when creating the user account, other verification information, and other data stored for the user inside the database in section of that user, this includes, but not limited too, the method where the another user kind provides data for a new user, see FIG. 6.

In the case of a payment to be made by a user, for further verification of address, a requirement of a credit card with that billing address to match the address of file will be required.

In order to auto fill portions, auto filled will be done as soon as the user opens a document but there will be other options on the document to manually check a box to auto fill, to edit and modify or to delete and clear certain fields. Once a user makes these changes to the document, the user may save and resume their work at any time with their changes.

User modification will be automatically recorded by date and time.

As previously explained in parts of this non provisional, the locations and or place contained in a file and files and or document or documents that require an individual or individuals to input and or write or provide certain information will be filled based upon accurate information with usage of database stored information, further the programming code PHP will be used and programming language may be added for the purpose to retrieve and input information on places that require an input information, additionally all information from sources for auto fill will be retrieve from database accurately.

User account will be viewable online and required online sign in and sign ups, desktop and device use will also be available. Upon account creation for a user, information will be asked for, verified, and stored in database. Additionally, upon a user-kind and selection, the user will have pre-filled applicable documents on their user dashboard, the file or files, doc or documents that will show up will be based upon selection.

There will be sections on document where user may add an image, based upon their user kind.

### Multi User ADF System (Detailed Description)

The Multi User ADF (auto document fill) system, is integrated with the user system in order to auto fill documents accurately per user as well as provide options to the user within the document aside from other user options the entire user based system, FIG. 1 No. 107, 108,109,110,111,112, and FIG. 5. Usage will be available online via a website and compatible by desktop.

With Multi User integration in the user system, an E-document will have capability to be auto filled, modified by each user on their separate dedicated user sections, resulting to the document to be able to be completed and modified by multiple users at one time. Multiple users execution is not required for document to be exported, a single user may simply auto fill, modify, complete their portion and then export their document or share. In a Multi User document completion, it provides ability for export, print and share for each user that finishes and executes their portion of information on the document, and once a document is executed by a user, it will show and update on the document in which another user will be connected to and or working on.

The auto fill data 106 information per user will be obtained from database containing information both by pre entered information and user information and other verified sources related to the individual who signs up as a user.

The user system also will record actions taken throughout the real estate buying, selling or leasing process and provide notifications. With everything recorded in the system it will promote ultimate safety for all parties.

A User may modify an e-document by deleting, typing, placing check boxes, import, on their dedicated portions of the document.

In Real Estate, there are certain disclosures by state that are mandatory to be provided to the future buyer and other such related individual in the transaction. This user system will have updated disclosures by state specified pre added to database. It will related and categorize users by state, by user/transaction kind and provide them auto disclosures on their user system and option of combining it on the final export.

Referring now to FIG. 8 to show A quick general overview of a process to show, but it is not limited to only this process as it is depending on the document and what parties are required to be apart of the document, there may be different parties involved. In an example, there is a existing listing of a property for sale 800, the future buyer makes an offer 801, the parties involved in the transaction are notified 802, the seller accepts the over 803, the parties involved are notified 804 and this offer acceptance is updated to their dashboard, there will be options to add other users to doc 805 (if necessary to be involved in the documentation), the starting process of documents will recommend a document for all to start off with, usually a pre-templet document (unless another document is added notified to be used for) 806, as the document opens it will be auto-filled 807 per user. 808 (along with -a-b) through 812 shows a process of each individual in the document having it auto-filled, working on their documents, modifying optionally, executing, and each party receiving the notification and update once there is a submitted request of execution. 8120A also provides again ability for an individual to add another party to the document if needed. 813, indicates a document once it is completed, 814, indicates that it will be stored in the database, 815 similarly (as previously indicted) that the parties will be noticed, 816 indicates that the individuals will have ability to save the doc and view it on their user dashboard, 817 indicates that options to send it, 818 indicates option to share, 819 indicates option for multi export of the file, 820, indicates option to print the doc.

In order to configure permissions onto the document, as stated, it will be based upon user kinds, a ‘user kind’ in the system and configured in database will either be a user such as a real estate agent such as a buyers or sellers agent, commercial agent, residential agent, broker, buyer, seller, notary, other licensed professional, and or other party involved in the document, see FIG. 4. There will be many features in the user system additionally integrated making the process much easier and helpful, involving API integrations.

To ease multi user document auto fill, there will be design elements such as highlighting areas of user portions as well as providing ease to keep users informed of which parts of the document are their portion, see FIG. 11-C. Simple Date and Timestamps will be auto stamped to documents on designated areas when a user saves the document, modifies, and or on final execution. Self help hover buttons on the E-document will be available, SEE FIG. 11-A. The user will have option to modify even after auto fill, save, and even share saved document to another user before final execution. The user will have option to export one or many documents in multiple formats or share.

### Multi-Conversion Export or Share (Detailed Description)

After a user has an auto filled document, user may make changes on areas allowed of the document and it will save to database, user then will have the option once the document if fully completed, to print the document and the document may also be converted to its original state (if it was pdf, the user may want to convert it to pdf again), but it will be a new document since it will display the auto filled information on the document. It may also be converted to other file types.

Refer now to FIG. 7. Once the document is complete, the user will have the option to export it 701 into many different file types with extensions available such as PDF, JPG, JPEG, WORD, and also more other nearly related formats, 704. The user will have option to select a bulk export for multiple documents at once 703 or a single export 702. In a single export, the title of the document and date will be stamped on the file name with its extension. The user may also request to share 705 the document(s) by a custom generated link for sharing purposes or the user may send the document(s) by email securely. The user will also have option to print the completed document(s) (708).

1. A method and system for transforming, converting, auto filling, preparing and completing documents related to real estate, property, contracts, professional agreements, and other such related legally binding documents, consists of:
A user and user system (with database) to allow single and multi user interaction;
An integration with a user based membership type system providing verified users options and permissions on user account and document(s) which will be accessible web-based online or by desktop app;
An ability for a user to accurately auto fill documents based upon sources such as data inside the users database;
A user will also have the option to upload their own documents and they will be imported and converted with an auto method;
An integration to provide different user-kinds permissions and options based upon their user level on the account and on a document and or document(s);
An ability for multiple users to work on one document at the same time, completing each of their sections individually;
An ability for users to modify, save, execute, share, print a document or documents they've finished, and or convert completed documents into another form by export it bulk or separately into multiple file formats primarily including PDF, WORD, JPG, and more;

2. In order to provide designated portions on a document, the user based system used in the present invention in CLAIM 1 will have different ‘user kinds’ set up on the database and specified on the programming code in order to provide multiple options and permissions for a user on a document as well as on the user system, the user kinds consist of:
User kinds will primarily be split up into a user category of a broker, an agent, buyer, seller, lessor, other business professional and or party title often in a legally binding agreement;
Permissions including certain viewing permissions, restrictions and options based on user-kind;
Custom coding of a document and or documents in compatibly with the user system added in portions of a document on areas requiring for certain party input, and party input will be categorized and coding split by different user kinds;
Custom coding of a document and or documents in compatibly with the user system added in places of input, categorized by different user kind in order auto retrieve user system integrated database information per user kind;
Custom coding of a document per user kind to set options, including but not limited too: A—Auto filling B—Modifying C—Saving D—Importing of media allowed on designated portions of the file, such as signature and other permissions and restrictions on designated portions of a document per user kind;
Custom coding of a document and or documents in compatibly with the user system to allow certain options, viewing permissions, modifications, import on sections of a document per user kind;
Pre-temple ready for use documents available based on a user kind and location;
User kinds include a buyer, seller, agent, broker, and other licensed professionals and or parties of a document;

3. In order to convert documents to make them electronic and integrated to the user based system with present invention of CLAIM 1, document(s) must first either be converted manually or by an automatic method, the 2 methods manual and automatic consist of the following:
Documents or files before coded may be in a PDF format, Word doc, .TXT format and or text document or form in any other format and image file or files containing text;
Conversion of an electronic document and or (documents), extracting the source, which will be its context and converting to a user system compatible programing language file and coding;
Adding media files to the document such as equal housing logo and leaving code for retrieval of other logo sized images if necessary;
Programming language may be in a PUP file and code, but not limited to other file types or codes as it is meant to code user options, permissions, and database retrieval in integration with a user system, per user kind specified, where appropriate;
After conversion to programing language file, programming language code will be added before or after or in between certain phrases or wordings and or letters and or symbols, further it will also replace &NBSP words and or blank spaces and or empty places meant for input by individual and insert custom PUP programming coding to retrieve and display certain information from database, other programing language may be inserted to provide restrictions and options per user kind;
Places of input on a document are often require first name of a person, last name, brokerage name, address, home address, real estate agent name, license number and other information based upon the document kind;
In an automatic search, find and replace method, first Auto searching within the document for certain pre data saved phrases, words, letters, often in places that require user input including ‘&NBSP’ phrases;
Then, Finding that match and then auto replacing with appropriate programing language code in configuration with the user system;

4. A document and or document(s) auto fill process the present invention in integration of CLAIM 1 with the user system consists of:
Auto fill of a document on designated user portions per user kind in integration with the user system;
Auto fill Data obtained by direct user input, specifically including user input in the sign up process and in the verification process;
Auto fill Data obtained by information from the users database, including, but not limited too, a broker or other authorized user imported data for a user to the database before account is claimed.
Auto fill upon user opening a document, unless, user has previously opened a document, auto filled, and modified data, in that case, modified data would show;

5. Once a document is complete by a user, either the user has completed is portion or the document is completed and executed by multiple parties, the ability of a user consists of:
Ability to share the document files in a link;
Ability to print document;
Ability to export the document files in bulk or in single;
Ability to convert and export the document files into multi such as in PDF, WORD, JPG, JPEG, and other text files commonly provided for documents.
